(19) United States
(12) Patent Application Publication
(10) Pub. No.: US 2024/0009696 A1
(43) Pub. Date: Jan. 11, 2024

(54) COATING MODULE WITH FLEXIBLE FILM

(71) Applicant: ARMOR, NANTES (FR)

(72) Inventors: Pierre-Olivier PENEAU, NANTES (FR); Klaus Peter CRONE, HENNEF (DE); Niklaus SCHNEEBERGER, KÖNIZ (CH); Alain SAURER, BÔLE (CH); Kai BACHOFNER, BERN (CH); Marc MEIENBERGER, BERN (CH)

(21) Appl. No.: 18/347,261

(22) Filed: Jul. 5, 2023

(30) Foreign Application Priority Data
Jul. 6, 2022 (EP) 22315137.4

(51) Int. Cl. B05C 11/02; B05C 5/02; B41J 2/325

(52) U.S. Cl. CPC B05C 11/028; B05C 5/0245; B41J 2/325

(57) ABSTRACT

A coating module to coat a substrate with a coating composition includes a coating device to apply a layer of coating composition on the outer surface of the substrate, and a flexible film including a distal portion designed to be in contact with the coated substrate.

### CROSS-REFERENCE TO RELATED APPLICATIONS

This application claims priority to European Patent Application No. 22315137.4, filed Jul. 6, 2022, the entire content of which is incorporated herein by reference in its entirety.

### FIELD

The present invention relates to a coating module to coat a substrate wherein the quality of coating is improved and relates to an associated method. The invention further relates to a thermal transfer printing apparatus comprising such coating module.

### BACKGROUND

Many coating techniques using free surface coating flows are well known from the skilled person to coat a substrate with a coating composition using rollers, spray, slot-die, screen-printing, extrusion, knives, blades, bars . . . .

However, in single/multilayer methods (i.e. dip coating, rod coating, knife coating, blade coating, air knife coating, gravure coating, forwards and reverse roll coating, slot and extrusion coating, slide coating, curtain coating, etc.), the coating compositions applied onto a substrate are likely to be subjected to flow instabilities impacting on the coated layer uniformity: periodic, waved variations in coating thicknesses referred as to ribbing are commonly observed over the coating surface regardless the coating technique or the nature of the coating composition. Therefore, it is a constant challenge to limit the appearance of ribbing and consequent flaws.

Fluid instabilities are complex by nature and small variations can propagate into large defects. Ribbings' origin can be manifold as it could be a consequence of small disturbances generated during the coating process within the coating composition. Its occurrence could depend on several factors: the coating composition features such as surface tension, viscosity, the coating process parameters such as coating speed, pressure, viscoelastic forces or shear rate locally applied, and the coating equipment's materials.

One limitation typically arises when to coat thin layers of a few grams per square meter (e.g., weight basis less than 30 g/m²) or to reach a final coated layer with a thickness below 200 μm at high coating speed, whereby the protruding aspect of the ribbing could be emphasized. The phenomenon of ribbing could also be highlighted or released in the downstream process of curing, drying or cooling whereby processing conditions such as temperature or relative humidity rate could also affect the final aspect of coated goods.

In general, the ribbing phenomenon refers to as a nonuniform coating resulting in a wavy thickness profile through the width and more-or-less steady in the coating direction. The onset of ribbing is a flow instability and may be deleterious or even lead to an unacceptable and permanent defect since the coating thickness varies in a sinusoidal way across the width. Stripes or ribs appear on the surface along the machine direction (also referred to as transport direction or coating direction). The defect could also be referred to as corduroy, rake-lines or phonographing. In practice, the mitigation of ribbing implies the modification of the coating speed, the coating viscosity, the wet coating thickness or an addition of surfactants to the coating composition. Those limitations are opposed to economical driving forces.

### SUMMARY

One or more aspects of the invention aim at providing a new coating module to cope with the emergence of ribbing, hence improving the homogeneity and the quality of a coated layer.

An aspect of the invention relates to a coating module to coat a substrate with a coating composition comprising a coating device to apply a layer of coating composition on the outer surface of the substrate, and a flexible film comprising a distal portion designed to be in contact with the coated substrate.

An aspect of the invention relates to a coating module to coat a substrate with a coating composition comprising: a coating device to apply a layer of coating composition on a first surface of the substrate, and a flexible film comprising at least one proximal end being mechanically connected to a holding element and a free distal portion configured to be in contact with the layer of coating composition on the first surface of the substrate.

A benefit is to smoothen the coated surface of a substrate after coating application with the free distal part of a flexible film. It has also been observed that one or more aspects of the invention enhance the overall quality of the coating layer by mitigation and reduction of other flaws caused by streaks.

According to an embodiment, the coating module comprises a conveyor system configured to support and transport a substrate by its inner surface or by a second surface of the substrate opposite to the outer surface. According to an embodiment, the conveyor system comprises a support roller.

According to an embodiment, the conveyor system comprises a temperature regulator configured to heat or to cool a portion of the substrate.

According to an embodiment, the flexible film further comprises openings, grooves or fibers.

According to an embodiment, the coating module further comprises a system to apply pressure on the distal portion of the flexible film.

According to an embodiment, the coating module comprises a holding element, the flexible film being fixed to the holding element, wherein the holding element is mechanically connected to a frame by one or two lateral extremities. A benefit is to maintain the position of the proximal end or ends of the flexible film while the distal free portion is in contact with the coated substrate.

According to an embodiment, the holding element is connected to the frame with at least one degree or freedom. A benefit is to adjust the position of the flexible film. Another benefit is to remove streaks between the flexible film and the coated substrate.

According to an embodiment, the holding element is removable from the frame.

According to an embodiment, the coating module comprises a source of electromagnetic radiations arranged to irradiate the distal portion of the flexible film and wherein the flexible film is transparent to such radiation. A benefit is to allow the transmission of electromagnetic wave as any desirable wavelength or orientation to reach reactive molecules, orient or polarize components of the coating composition.

Another aspect of the invention further relates to a coating system comprising a coating module according to the invention and a substrate. The coating device is arranged to coat a surface of the substrate. The flexible film is arranged to be in a planar contact with the coated substrate. According to an embodiment, the flexible film is arranged in such a way that its distal portion is in a planar contact with the coated substrate.

Another aspect of the invention further relates to a thermal transfer printing apparatus. The thermal transfer printing apparatus comprises a coating system according to the invention wherein the substrate is an endless ribbon. The thermal transfer printing apparatus comprises a conveyor system comprising a set of rollers to transport the substrate along a path, a printing roller to transport a printing support in contact with the outer surface of at least a portion of the substrate; and a printhead arranged to thermally transfer a part of the coated ink from the outer surface of the substrate to the printing support in contact with the substrate.

Another aspect of the invention further relates to a system for producing an endless ribbon comprising a coating system according to an aspect of the invention, wherein the substrate comprises a coating drum. A benefit is to form thickness-uniform endless ribbon or band over the coating drum using for example a dip coating method. The system beneficially also comprises a cylinder and a system adapted to rotate such as a motor or a couple rotor/stator the coating drum around a longitudinal axis of said cylinder.

Another aspect of the invention further relates to a method to coat a substrate.

In an embodiment, the method comprises coating the outer surface of the substrate with coating composition. The method further comprises suspending a flexible film to a holding element and transporting the substrate by its inner surface along a predetermined path, in such a way that a free portion of the flexible film lays over the coated outer surface of the substrate before its solidification, dryness or complete cure.

In an embodiment, the step of coating comprises coating the outer surface of the substrate with at least two bands in parallel, separated one from each other, and wherein the coating module comprises at least two flexible films; each flexible film is arranged to lay over one band of coating.

In another alternative embodiment, the method comprises coating the outer surface of the substrate with a coating composition with a coating device and transporting the coating device and a flexible film along a predetermined path, in such a way that a portion of the flexible film lays over the layer of coating composition before its solidification, dryness or complete cure.

### BRIEF DESCRIPTION OF FIGURES

FIG. 1 is a schematic sectional view of a coating module according to a first embodiment of the invention using a slot-die coating device.

FIG. 2 is a schematic view of a coating module according to a second embodiment of the invention wherein the coating device comprises an ink roller.

FIG. 3 is a schematic cross-sectional view of the flexible film of the coating system according to an embodiment of the invention.

FIG. 4 is a perspective view of the flexible film of the coating system according to another embodiment of the invention wherein the flexible film comprises openings and wherein the coating module comprises a system adapted to maintain a distal portion of the flexible film in contact with the coated layer of coating composition.

FIG. 5 is a schematic cross-sectional view of the flexible film of the coating system according to another embodiment of the invention wherein the two longitudinal extremities of the flexible film are mechanically connected to the holding element.

FIG. 6a is an illustration of a coated layer showing the ribbing phenomenon captured by a microscope.

FIG. 6b is an illustration, captured by a microscope, of a coated layer coated with a coating module according to an embodiment of the invention wherein the flexible film is 12 μm thick and made of polyester.

FIG. 6c is an illustration, captured by a microscope, of a coated layer coated with a coating module without flexible film and wherein the coating device comprises an ink roller comprising surface defect.

FIG. 6d is an illustration, captured by a photometer, of a coated layer coated with a coating module according to FIG. 6c further comprising a flexible film according to one embodiment of the invention.

FIG. 7 is a schematic cross-sectional view of the flexible film, and the holding element according to an embodiment of the invention, wherein the coating module comprises wounding elements to store at least one portion of the flexible film.

FIG. 8 is a schematic view of a thermal transfer printing apparatus according to an embodiment of the invention.

FIG. 9 is a schematic view of a coating module according to an embodiment of the invention, wherein the substrate to be coated comprises a coating drum.

FIG. 10 is a schematic view of a coating module according to an embodiment of the invention, wherein the substrate to be coated comprises a coating drum and further wherein the coating device comprises a knife coating device.

FIG. 11 is a schematic view of a coating module according to an embodiment of the invention wherein the coating device and the flexible film are transportable.

FIG. 12A is a schematic view of the flexible film and cleaning system adapted to clean the flexible film.

FIG. 12B is a schematic view of the flexible film attached to the holding element according to an embodiment wherein the flexible film is an endless film and wherein the coating module further comprises a system to wash a reserve portion of the flexible film.

### DETAILED DESCRIPTION

In the present application, the term “inner surface” should be understood as the surface of a substrate, optionally in contact with a conveyor system. In opposition, the term “outer surface” should be understood as the surface of the substrate receiving a coating composition.

In the present specification, “substrate”, “coated substrate”, “coating layer”, or “coated layer” will be used indifferently to refer to as any surface receiving a coating composition, in contact with the flexible film. Such surface comprises a free flow coating composition designed to produce any kind of coating or laminate such as a precoat, skin coat, topcoat, back coat, covering, varnishing, finishing, adhesive for film laminating . . . .

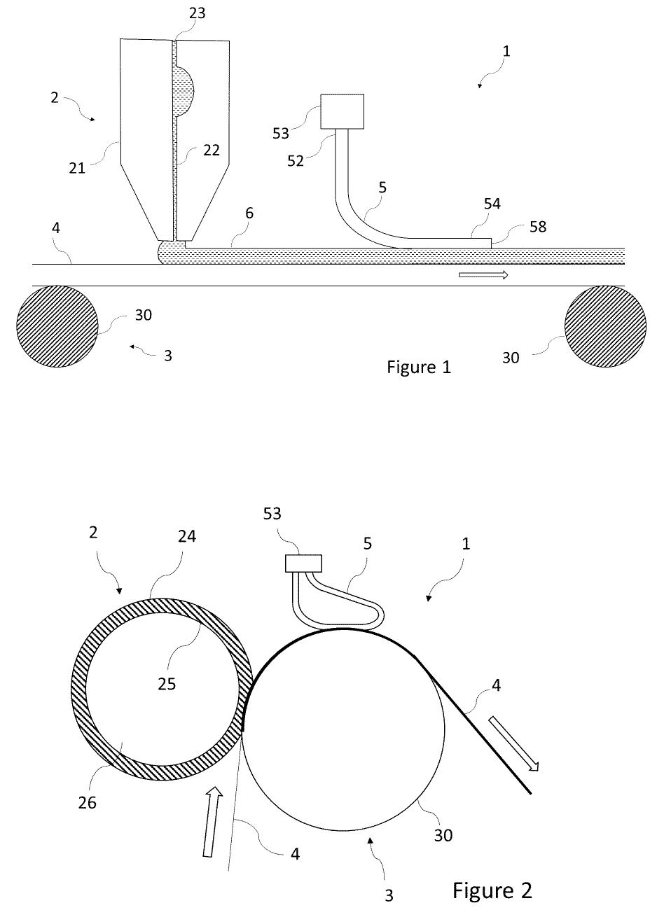

FIG. 1 shows a first example of a coating module 1 according to an embodiment of the present invention.

The coating module 1 comprises a coating device 2 to apply the coating composition 6 over the outer surface of the substrate 4 while it is transported along a predefined path by a conveyor system 3. The coating module 1 further comprises a flexible film 5.

Coating module 1 could encompass any kind of coating device and the flexible film is made compliant with any coating technique available to the skilled person: flexography, free flow and curtain coating, dip coating, brushing, roll coating (forward roll coating, reverse roll coating . . . ), spraying, painting, brushing/wiping, extrusion coating . . . for direct or transfer (indirect) coating.

The use of the flexible film within the coating module could be embedded in any continuous coating process. Various aspects of the invention are especially adapted to free flow coating wherein the final coating surface ought to be homogeneous and smooth.

The coating device is used to dispense the coating composition over the upper surface of a substrate. The coating composition flows to cover an entire or a sectional area. Hence, the flexible film could be designed to improve the coated layer evenness applied over the substrate, in full or in parts for strip coating or intermittent coating, for instance.

The coating process could comprise a single coating step or a multi-step coating, whereby a succession of coating composition could be applied over a previous coated layer such as a precoat, which could be tack-free or not.

The coating module could also combine several different coating techniques in a multi-method coating. The coating could be operated horizontally, vertically or obliquely with an angle. In double-side coating, the inner surface and the outer surface may switch during the process. The flexible film is installed to ensure its contact with the coating composition while said coating composition is still free flowing, i.e. liquid, viscous or molten, regardless its viscosity. It is therefore beneficially placed between the coating device and a cooling, curing or drying equipment.

Flexible Film

During coating, the flexible film is intended to be in contact with the coated substrate. The coating layer is applied over the outer surface of the substrate. The flexible film operates before the coating composition is cured, dried or cooled down, when coating leveling remains possible, i.e. before its surface becomes tack free. The flexible film allows to cope with imperfection and flaws over any kind of coated product avoiding ripples, crimps, wobbling, and/or waiving . . . .

To be held over the substrate, at least one end of the flexible film is attached to a holding element. The flexural ability of the film allows a distal portion to cover part of the coating layer freshly applied to the substrate, while the coating composition could still exhibit a suitable thermo-mechanical behavior to be leveled or otherwise smoothened. The coating flattening, levelling or equalizing operation takes place in a process window arranged to cope with ribbing and to remove thickness unevenness.

In an embodiment, because of the movement of the substrate according to the coating direction and the flexibility of the flexible film, a distal portion of the flexible film is dragged by said substrate. Hence, the coated layer slides underneath or along the distal portion of the flexible film.

The flexible film is arranged and designed in such a way that a face of a distal portion of the flexible film is in contact, for example in planar contact, with the coated layer of the substrate.

By “planar contact”, it should be understood that the distal portion of the flexible film lays over, superposes or juxtaposes the upper coated layer of the substrate. A face of the distal portion 54 of the flexible film exhibits a surface in contact with the coated layer of the substrate.

The length of the flexible film is designed to be long enough to ensure a planar contact between the distal portion and the coated layer. The length of the distal portion of the flexible film could be superior to 0.5 mm, and in an embodiment above 1 cm according to the coating direction.

In an embodiment, the coating module is able to coat simultaneously at least two portions of the substrate's width, forming at least two bands or stripes of coating. According to an example, the coating module comprises a shim. The shim comprises at least two apertures and is arranged to guide the coating composition through the aperture to form on the surface of the substrate at least two separate bands or stripes of coating.

In an embodiment, the coating module comprises at least two flexible films. In an embodiment, the at least two flexible films are arranged in the same plane fixed to the holding element and each flexible film is arranged to lay over a portion of the width of the substrate. In an embodiment, each flexible film is arranged to lay over one band of coating, over the outer coated layer or substrate.

Single-End Fixation

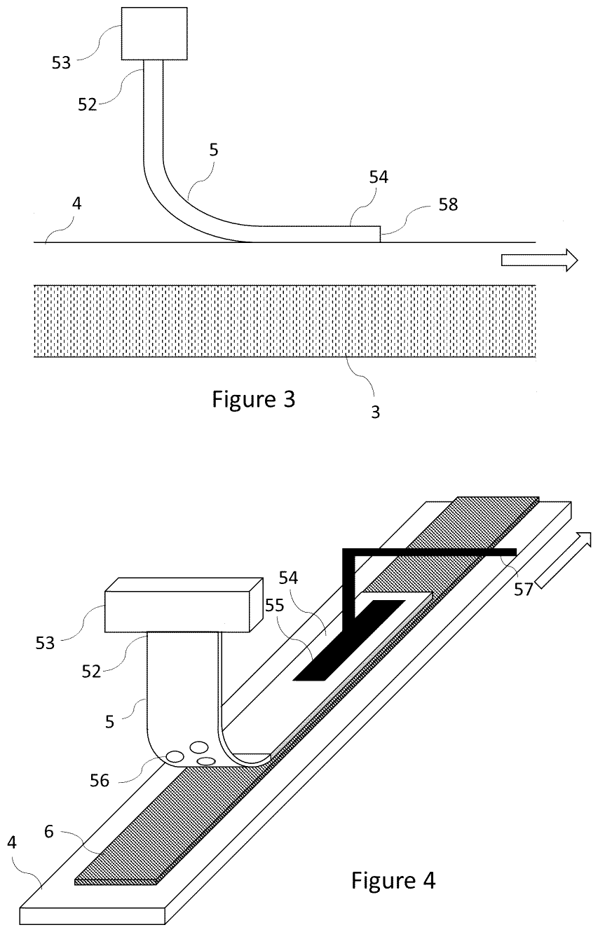

In a first embodiment illustrated in FIG. 3, a proximal end 52 of the flexible film 5 is mechanically connected to a holding element 53. The holding element 53 is for example mechanically connected to the frame of the coating module. In an embodiment, the proximal end of the flexible film is mechanically connected to the holding element 53 with 0 degree of freedom.

In other words, the flexible film is fastened and hung onto the holding element 53 by its proximal end above the coated substrate 4 transported by the conveyor system. Because the length of the flexible film 4 is superior to the distance between the holding element 53 and the coated substrate 4, a distal portion 54 of the flexible film bends and lays over the coated substrate 4, overlapping a section of the upper coating layer 6.

Double-End Fixation

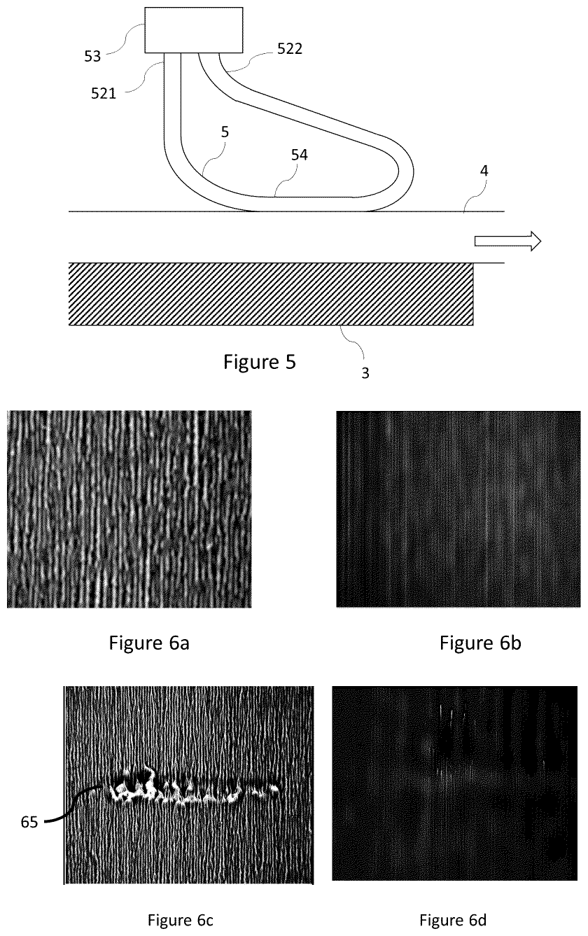

In a second embodiment illustrated in FIG. 5, both ends of the flexible film 521, 522 are mechanically connected to the holding element 53. In this embodiment, the flexible film 5 forms a closed loop. A distal portion 54, away from the holding element is arranged to be in contact with the coated layer 6. A first benefit is to prevent flaws due to eventual miscut or sharp endings 58 of the flexible film. A second benefit is to reduce the risk of losing contact between the flexible film and the coated substrate, applying a slight pressure when the film bows over the substrate. A third benefit is to reduce the risk of misalignment between the distal portion 54 of the flexible film 5 and the substrate.

In both the first and second embodiment, the flexible film could be arranged to be in contact with the substrate as close as possible from the coating device.

### ADDITIONAL EMBODIMENTS

Other embodiments are described below in combination with the above-mentioned first or second embodiment.

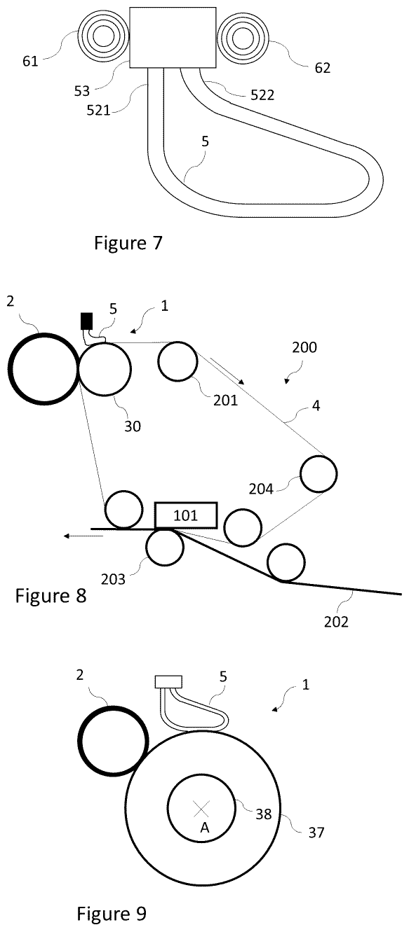

In an embodiment illustrated in FIG. 7, the coating module comprises at least one unit 61 or 62 to wind-out a portion of the flexible film. In an embodiment, at least one winding unit is designed to store an amount of film.

In a further embodiment, the coating module comprises a first unit 62 and a second unit 61. The first unit and the second unit are, in an embodiment, mechanically connected to the holding element 5. The flexible film is maintained between the first unit 61 and second unit 62, forming a storing unit for the flexible film in such a way that the length of the flexible film from the first unit to the second unit is superior to the distance between the first and the second unit. A benefit is to regulate the distal portion 54 of the flexible film in contact with the freshly coated layer 6.

In an embodiment, the first unit and/or the second unit comprises at least one winder. The user can unwind the flexible film from the first unit 62 and cut the old part of the flexible film to renew the distal part of the flexible film intended to be in contact with the coated layer. In an embodiment, the first unit and/or the second unit comprises at least one motor to control said winder and its rotation speed.

When the flexible film is wound out of the first unit and wound into the second unit, its distal portion in contact with the coated layer can be renewed. The reserve of the flexible film stored within the first unit is rolled out and spread out over the coating layer. The unwound portion of the flexible film become the new distal portion. A benefit is to replace continuously the distal portion of the flexible film.

In an embodiment, the coating module 1 further control a degradation sensor designed to measure the degradation of the flexible film. The degradation sensor may comprise at least one optical sensor. In an embodiment, the coating module comprises a system (such as a controller controlling the motors of the first and/or second unit) adapted to automatically replace the distal portion of the flexible film when the degradation measured by the degradation sensor reach a predetermined threshold. A benefit is to automatically replace the distal portion of the flexible film.

The holding element 53 is, in an embodiment, mechanically connected to the frame of the coating module 1. The holding element 53 beneficially comprises a fixing system adapted to affix one or two ends of the flexible film 5.

In an embodiment, the coating module 1 comprises at least two flexible films 5 and each flexible film 5 is fixed to a holding element 53. In multiple coating steps, an array of many flexible films as described before could be connected to the same frame or operated independently. Each holding element 53 may be mechanically connected to the frame of the coating module 1 with at least one degree of freedom in rotation or in translation. This degree of freedom beneficially allows the alignment of the flexible film as well as an ease to replace the flexible film 5.

In an embodiment, at least one end of the flexible film is attached with double-sided tape to the holding element. The flexible film could be glued, clamped, nailed, fixed with screws, riveted to the holding element 53.

In another embodiment, the coating module comprises a system adapted to easily change or replace the flexible film 5. In an example, the first unit 61 and/or second unit 62 are removable connected to the holding element 53 or to the frame. In a second example, the flexible film is connected to the frame or to the holding element by any removable fixing system such as a screw, a tong, an adhesive or magnetic fixing system (e.g. a magnet). In an embodiment, the holding element may be or joined together with a drying unit described hereafter.

In another alternative embodiment, the flexible film and the holding element may be attached to a portable supporting device intended to be placed on the ground and intended to hang the flexible film above a substrate according to the invention.

In another embodiment, the coating module further comprises a system adapted to provide a lateral movement to the flexible film. The system could induce vibration to provide vibration to the flexible film. The vibration of the flexible film may improve the reduction of the ribbing effect on the coated layer 6. Another benefit of the vibration is to improve the removal of flaws caused by streaks: presence of particles, dust, bubbles, prematurely dried coating, small chunk, lumps or caused by nicks in the coating device. The quality of the coated layer could be therefore improved by mitigation of air pockets within the coating composition remaining after filtration or any other operation carried out before actual coating.

In an embodiment, the vibration system may comprise a motor controlling the holding element or a piezoelectric element to carry out the vibration function. In an embodiment, the coating module comprises a controller. The controller controls the vibration system. In an embodiment, the controller is configured to automatically activate the vibration system to provide the flexible film to a vibration periodically and/or when streaks are detected between the flexible film and the substrate.

In an embodiment, the coating module comprises a system adapted to provide a translation or a rotation of the holding element 54. In an embodiment, the axis of rotation is sensibly parallel to the length direction of the flexible film. By “sensible”, it is meant that an angle between the axis of rotation and the length direction is less than or equal to +/−5 degrees.

In an embodiment, the holding element is mechanically fixed with the frame with at least one or two degrees of freedom in translation and/or in rotation. A benefit is to allow the holding element to move to adjust the position of the flexible film with the orientation and the position of the substrate.

In an example, the holding element is free in translation, in a first direction perpendicular or sensibly perpendicular (e.g. +/−5 degrees) to the surface of the substrate. A benefit is to adjust the length of the distal portion in contact with the substrate.

In an alternative or cumulative example, the holding element is free in translation in a second direction parallel or sensibly parallel of the direction of transport of the substrate. A benefit is to mitigate or remove streaks.

In an embodiment, the movement of the holding according to the second direction is controlled by a controller. In an embodiment, the controller is configured to automatically provide periodically a movement (such as a back-and-forth movement) of the holding element according to the second direction to remove streaks.

In an embodiment, the coating module comprises a sensor such as an optical sensor to detect streaks between the flexible film and the substrate. The sensor is connected to the controller and the controller is configured to initiate the movement of the holding element in function of the sensor measurement.

In an embodiment, the flexible film is suspended from the holding element in such a way that the direction of the film from its proximal end to the distal portion is sensibly aligned with the direction of transport of the substrate.

In an embodiment, the film 5 is arranged in such a way that the film 5 and the substrate 4 are aligned edge to edge and optionally, the width of the substrate 4 is equal or sensibly equal to the width of the flexible film. The flexible film 5 is curved over the coated surface and aligns or orients itself according to the transportation or coating direction induced by the conveyor system. Another benefit of such a design is to spread or level the coating over the outer surface of the substrate and to accurately control its width edges.

In an embodiment, the width of the flexible film is comprised between 100% and 50% of the width of the substrate.

In another embodiment, the coating composition is applied in a central portion of the substrate. In such embodiment, the width of the flexible film could be adjusted to control the spread out of the coating composition beyond its initial width, resulting in a subsequent width and thickness regulation.

The flexible film chemical composition could be chosen but not limited to any of the following materials or their combination. The flexible film could be based on a thermoplastic, thermoset or elastomer polymer and comprise at least one polymer chosen from among polyester, polyamide, polycarbonate, polyolefins, polysulfone, polyurethane, vinyl or cellulosic derivate, fluorinated or chlorine derivate, poly aryl ether ketone, polybenzimidazole, polyethylene glycol, polyimide, polyurethane, acrylic styrene, acrylic copolymer and a mixture thereof. The flexible film may beneficially be made of a material based on polyethylene terephthalate (PET) or its derivate, polyimide, PTFE (for “Polytetrafluoroethylene”) or PEEK (for “Polyether ether ketone”).

In another embodiment, the flexible film is a metal foil or sheet such as aluminum. In another embodiment, the flexible film comprises a combination of polymer and metal layers. In another embodiment, the flexible film contains at least one filler chosen from among powders, fibers, whiskers, particles, nanosheets . . . . Fillers could be chosen from among carbon, carbon black, graphite, graphene, carbon nanotube, activated carbon nanotube, activated carbon fiber, non-activated carbon nanofiber, metal flake, metal powder, metal powder, metal fiber.

The material and the thickness of the flexible film allow the flexible film to be in contact with the substrate along a distal portion, said distal portion is supported by the substrate in motion.

In an embodiment, the film is tailored to be transparent or opaque to electromagnetic fields. The flexible film may be transparent to Ultraviolet (UV) radiation to trigger photochemical reactions when UV-curable compositions are used. This embodiment is particularly beneficial for thick coatings. Indeed, the reaction of solidification may beneficially be triggered in depth (deep-through cure). Therefore, reaction could be initiated within the bulk coating while the surface remains liquid, which allows the flexible film to improve the quality of the upper coated layer. Conversely, the film may block such electromagnetic wave to prevent premature curing near the coating device in a luminous environment, for instance.

In another embodiment, the flexible film could be transparent, permeable, or porous to other types of radiation such as electron beam, laser, plasma, corona . . . . The flexible film may also be transparent to and transmit an electromagnetic wave, such as a rectilinear, circular or elliptic wave used to polarize the coating composition in-situ.

In an embodiment, the Young modulus of the flexible film is inferior to 10 GPa, for example under 5 GPa. The thickness of the flexible film is superior to 1 μm. In an embodiment, the thickness of the flexible film ranges from 3 μm to 50 μm, for example from 3 μm to 15 μm. Such a thickness of flexible film is beneficially adapted for the coating of thin layers (e.g., a layer inferior to 100 μm thin).

In another embodiment, the thickness of the flexible film is superior to 50 μm or, in an embodiment, superior to 100 μm. Such a thickness of flexible film beneficially allows an easier manual handling of the flexible film and helps to maintain the contact between the flexible film and the coated substrate.

Optionally, the basis weight of the flexible film could be lower than the wet coating basis weight. A benefit is to ensure a better control of the homogeneity of the thickness of the coating layer. In an embodiment, the basis weight of the flexible film is inferior to 30 g/m², and in an embodiment inferior to 20 g/m². The combination of mechanical properties and chemical/physical features of the flexible film could be chosen or tailored as to ensure the formation of a free, floating curvature of the flexible film between the holding element and the distal portion in planar contact with the coating.

In an embodiment, at least one surface of the flexible film 5 is textured.

In an embodiment, the flexible film comprises a texture over a limited area. In an embodiment, grooves are distributed over the closest area to the holding element, allowing the last part of the distal portion in contact with the substrate. A benefit is a progressive effect smoothing of the flexible film onto the coated layer.

In an embodiment, the flexible film comprises grooves, in a pattern or randomly displayed.

The grooves are, in an embodiment, made by laser ablation. The grooves may comprise a plurality of grooves extending in a direction which is not parallel to the direction of transport of the substrate.

A benefit is that the oblique grooves allow the creation of a perturbation of the coated layer 6 onto the substrate 4. Hence, the grooves beneficially reduce the ribbing when leveling complex coating compositions is difficult to be reached otherwise.

In an embodiment, the grooves extend along the surface of the flexible film 5 along a direction showing an angle from 10° to 30° with the direction of transport of the substrate. It has been surprisingly found by the inventors that this specific orientation of the grooves further improves the quality of the coating. Indeed, such arrangement induces an additional shear over the upper coated layer and leads to a significant reduction of the ribbing effect.

In an embodiment, the depth of the grooves ranges between 1 and 10 μm. In an embodiment, the width of said grooves ranges between 0.5 and 10 μm.

In one embodiment illustrated in FIG. 4, the flexible film 5 comprises at least one opening 56 or a plurality of openings 56. In an embodiment, the openings are arranged on the flexible film 5 on a portion between the distal portion 54. In an embodiment, the openings 56 are arranged in the vicinity of the distal portion 54 of the flexible film 5 in contact with the coated layer 6.

The openings 56 beneficially help maintain the distal portion 54 in contact with the coated layer on the substrate.

Indeed, when the speed of the substrate 4 is raised, the resistance of the air against the flexible film 5 may cause the detachment of the flexible film 5 from the coated layer 6 and, therefore, may reduce the quality of the coating. In addition, openings could also provide pores, holes to the flexible film for radiation to pass through and reach the coating composition as described above.

The openings 56 are, in an embodiment, through holes along the two surfaces of the flexible film. In an embodiment, the surface of the openings ranges from 1 μm² to 10 μm².

In an embodiment, the flexible film 5 exhibits two faces with different surface energies. Optionally, the surface of the flexible film in contact with the coated layer 6 is more oleophilic or hydrophilic than the outer surface of the substrate 4 in contact with the coated layer and vice versa. In an embodiment, the flexible film 5 is made of an oleophilic material and the outer surface of the substrate is made of oleophobic material. Tailoring the surface tension of the flexible film according to the coating composition enhances its contact with the distal portion. In an embodiment, the surface energy of the film is sensibly 50 mN/m on both sides. Hence, the effective contact of the distal portion of the film with the coated layer could be enhanced through capillary forces and the shear in the fluid creates the equalizing effect.

In an embodiment, the flexible film is designed to adjust spreading of the coating composition across its width, controlling its distribution.

In an embodiment, the flexible film comprises a fibrous structure. In an embodiment, the fibrous structure is arranged into a fabric. The fabric could comprise a woven, nonwoven, knitted, braided or any other kind of open or closed structure.

In an embodiment illustrated in FIG. 4, the coating module 1 further comprise a system adapted to apply pressure over the distal portion of the flexible film to keep it in contact with the coated layer.

In an embodiment, such a system comprises a plate 55 intended to be in planar contact with the outer surface or the flexible film 5 and may further comprise an arm 57 to generate a force on the plate 55 over the distal portion 54 of the flexible film 5, towards the substrate 4. Therefore, this plate 55 beneficially pushes the flexible film 5 to maintain contact between the flexible film 5 and the coated layer 6. The arm 57 may be movable in translation and/or in rotation regarding the frame of the coating module 1 to generate a force by the plate 55 toward the substrate 4.

In another embodiment, the system adapted to apply pressure on the distal portion of the flexible film comprise a fan arranged to generate an air flow toward the distal portion of the flexible film. In this case, the pressure is applied by air. In another embodiment, the system adapted to apply pressure comprises any kind of pressing element like a roller.

In an embodiment, the plate 55 comprises a system to be fixed to the flexible film. The plate 55 may comprise a device to bond, link, stick or adhere to the flexible film.

For example, the plate 55 may comprise an adhesive, or a suction system. These devices beneficially allow the plate 55 to remove the flexible film when the arm 57 removes the plate 55.

A benefit is a better control of the coating distribution in width while the coating composition slides along the flexible film. As a matter of fact, one could coat a narrower part of the substrate and force the coating layer to spread out across the width direction, given the flexible film exhibits relevant wetting properties with the coating composition. This set-up could be beneficially used in combination with pressure applied to maintain or press the flexible film against the coated layer. For a lower amount of coating poured or applied over a substrate, the coating width is enlarged, and the thickness could be flawlessly lowered, opening new process windows allowing the management of coating stripes and intermittent coating.

The plate 55 may also conduct electricity and be connected to the system ground. A benefit is to improve electrostatic dispersion and reduce the risk of spark and fire. In an embodiment, the plate 55 is made of metal or is made of conductive plastic.

In another improved embodiment, the flexible film is made of an electrically conductive material and the coating module comprises a system adapted to allow passing an electrical current through the flexible film.

A benefit is that the passage of the electric current orients the polar molecules of the coating composition or conductive fillers. The coating module may comprise an electrical generator connected to the flexible film for transmitting an electromagnetic field through the flexible film.

In an embodiment, the coating module 1 further comprises a system adapted to remove the flexible film 5 from the substrate or from the coated layer. In another embodiment, the flexible film can be optionally removed for its replacement in the performance of a maintenance operation, for instance.

Conveyor System

The coating module may comprise a conveyor system 3. The conveyor system is designed to support and transport the substrate 4 along a predefined path. In an embodiment, the conveyor system is designed to drive the substrate from the coating device to the flexible film.

In an embodiment, the conveyor system is designed to drive the relative speed of the substrate in a controlled manner during coating.

In an embodiment, the conveyor system 3 is designed to hold and transport the substrate 4 by its inner surface along a predefined path.

The conveyor system 3 may comprise at least one roller 30. In an embodiment, the conveyor system 3 comprises at least one drive roller. The drive roller is connected to a motor to rotate the drive roller. The rotation of the drive roller beneficially drives the substrate.

The coating module 1 may further comprise a motor to rotate the drive roller of the conveyor system and a speed controller coupled to the motor generating a rotation of the drive roller. Then, the speed of the substrate along its path is related to the speed of rotation of the drive roller of the conveyor system and controlled by the speed controller.

In an embodiment, at least one battery or an electrical alimentation may be implemented in the conveyor system to provide power supply to the motor.

In another non-illustrated embodiment, the support roller 30 may be replaced by a guide for guiding and supporting the substrate 4 by its inner face. The guide is, in an embodiment, a curved guide or a partially rounded shape guide. The guide is static with respect to the frame of the coating module. This guide may be flat or present a curve surface to guide the movement of the substrate 4.

Coating Composition

The coating composition may be a solution, a slurry, a dispersion, an emulsion, a paste, an ink, a slurry, or any liquid, fluidic, solvent-based, molten, or viscous composition or any type of chemical composition. The coating composition is intended to solidify, be dried, cured or cooled down after being applied over the outer surface of the substrate and after passing underneath the flexible film. The coating composition could also comprise a sol-gel composition or comprise any transient composition or polymeric composition in between a fluid and a solid state.

The coating composition may comprise one or more polymers selected from thermoplastic polymers, thermoset polymers, elastomers, and mixtures thereof.

Examples of thermoplastic polymers include, but are not limited to, polymers derived from the polymerization of aliphatic or cycloaliphatic vinyl monomers, such as polyolefins (including polyethylene or polypropylene), polymers derived from the polymerization of aromatic vinyl monomers, such as polystyrenes, polymers derived from the polymerization of acrylic and/or (meth)acrylate monomers, polyamides, polyether ketones, polyimides.

Examples of thermosetting polymers include, but are not limited to, thermosetting resins (such as epoxy resins, polyester resins) optionally mixed with polyurethanes or with polyether polyols.

Examples of elastomeric polymers include, but are not limited to, natural rubbers, synthetic rubbers, styrene-butadiene copolymers, ethylene-propylene copolymers, and silicones.

The coating composition may comprise one or more fillers.

Examples of fillers include, but are not limited to, carbon, graphite, graphene, metal, oxides, and ceramics.

The shape of fillers could be, but are not limited to, particles, flakes, powders, fibers, nanofibers, nanotubes, whiskers, aggregates, and sheets in all dimension ranges.

The coating composition may be any combination of all the above.

In an embodiment, the coating composition comprises a solvent and the evaporation of the solvent leads to the dryness or solidification of the coating composition. In this embodiment, the coating module may comprise a system adapted to accelerate the evaporation of the solvent such as a heat source or an air blow. In an embodiment, the heat source or air flow are oriented towards the coated outer surface of the substrate after its passage along the flexible film.

In an alternative embodiment, the coating composition comprises a molten ink. The molten ink is intended to be cooled down and solidified after being coated. In an embodiment, the coating module comprises a system adapted to accelerate the solidification of the coated layer such as a cooler. In an embodiment, the cooler may comprise a cooling roller 201 as illustrated in FIG. 8. Said cooling roller 201 is arranged to support the inner surface of the substrate to cool down the coated composition through the substrate. In an embodiment, the flexible film is arranged to slide over the coated substrate between the coating device and the cooler or the cooling roller.

In another alternative embodiment, the coating composition comprises chemical compounds reacting with an electromagnetic field, such as polarizable molecules or photo-initiators. In the example of photo-initiators, these compounds allow to UV-cure the coating composition upon UV radiation.

In this embodiment, the coating module comprises a curing unit to expose the coated layer to radiations. In an example, the curing unit is arranged to expose the coated layer to UV radiation through the flexible film to initiate the photoreaction as described above. In this embodiment, as explained before, the flexible film is transparent or permeable to such radiation.

In any cases, the physical, chemical, or mechanical features of the flexible film are selected depending on the coating composition.

The Substrate

The substrate 4 can be any surface to coat. Optionally, it is a flat surface such as metal, glass, paper, fabric, or plastic. In one embodiment, the substrate is a sheet or a foil. In an embodiment, the substrate comprises a ribbon such as a polyimide ribbon. The ribbon may be a band or an endless ribbon. In one embodiment illustrated in FIG. 9, the substrate is a coating drum 37 as explained in the following description.

Coating Device

The coating device 2 may be any kind of coating device able to coat a layer of fluid on a substrate. The coating device is designed and arranged to apply a layer of coating composition onto the outer surface of the substrate, for example a wet coating basis weigh inferior to 30 g/m² and/or, in an embodiment, a layer having a thickness lower than 100 μm.

In an embodiment, the coating device is mechanically connected to the frame of the coating module.

The coating device is intended to apply a layer of a coating composition on the outer surface of the substrate. The coating device is arranged to apply the coating composition on the substrate within a so-called “coating zone”. The “coating zone” may be defined by a portion of the substrate in contact with part of the coating device or the portion of the substrate on which the coating composition is applied. This “coating zone” may correspond to the length of the substrate receiving new ink from the coating device.

In an embodiment, the coating device is designed to coat both surfaces of a substrate. The coating composition could exhibit a very low viscosity close to water's as well as viscosity up to several thousand of centipoises. The coating composition is cured or solidified using conventional techniques such as to dry solvent-based or water-based compositions, to induce polymerization or crosslinking reactions, to trigger radiation-curable compositions, or to cool down molten coating compositions.

In an embodiment, the flexible film is arranged in such a way that the distal portion of the flexible film is in contact with the upper coated layer.

As illustrated in FIG. 6b, the quality of the coated layer obtained using a coating module according to the invention with the flexible film is more homogeneous than the one obtained without such flexible film illustrated in FIG. 6a. Indeed, the surface aspect of the coated layer in FIG. 6b has been obtained with a flexible film 12 μm thick and 22 mm long comprising polyester.

On FIGS. 6a and 6b, the white pixels show surface with low thickness of coating and the black pixels surface show surface with high thickness of coating.

It could be seen that aspects of the invention beneficially improves the homogeneity of the coating over a substrate which is particularly beneficial, e.g., to coat ink donor ribbons for thermal transfer printing applications.

Another benefit of the flexible film is to remove defects from the coated layer induced by a defect over the outer surface of the ink roller.

The inventors further surprisingly found that such flexible film is very efficient to limit the effect of defects over the outer surface of the ink roller.

On example is illustrated while comparing FIGS. 6c and 6d. In both cases, the coated layer has been coated by a coating device comprising an ink roller 24 as illustrated in FIG. 2. The same coating portion has been recorded using a microscope or a telecentric camera system with backlight to check the quality of the upper coted layer.

As a matter of fact, when the ink roller 24 exhibits some defects over its outer surface subsequent flaw appears on the coated layer. Such flaw rises onto the coated layer, as shown in FIG. 6c, due to the abnormal presence of indentation on the ink roll. When using the flexible film according to the invention, the inventors observed that the impact of such defects 65 is annihilated, as illustrated in FIG. 6d. The ink roll defect generates flaws onto the coated layer over the same part of the coated substrate but disappears when using the flexible film. Hence, not only the coating ribbing has been mitigated but also the flaws caused by defects over the outer surface of the ink roller.

The use of the flexible film could therefore limit the replacement of damaged ink roller while maintaining high quality of the coated layer. Therefore, an aspect of the invention beneficially allows to limit the ink roller replacement, increases the use of the coating module and increases the overall process throughput and yield.

According to an embodiment, when the coating composition needs to be softened or melted, the coating module 1 comprises one or more additional heating devices. Additional heating devices ensure that a temperature of the coated layer 6 is superior to the melting point of the coating composition or superior to the glass transition temperature of the coating composition until said coated layer 6 reaches the distal portion 54 of the flexible film 5. This additional heating devices ensure the coating composition is kept liquid or viscous enough to be skewed in contact with the distal portion 54 of the flexible film.

The additional heating devices keep the coating composition at a sufficient low viscosity so that the capillarity forces can enable the interaction between the film and the substrate. Therefore, in an embodiment, the flexible film is designed to reach a level of flexibility in such a way that capillary forces can manage the interaction between the flexible film and the substrate.

As illustrated in FIG. 3, the distal portion 54 of the flexible film 5, is in contact with the coated layer 6 supported by a support element 30 such as a support roller. In an embodiment, the distal portion 54 of the flexible film 5, in contact with the coated layer 6, is supported by the conveyor system 3 or the support roller 30. In an embodiment, the support roller 30 comprises a heating device such as electrical resistance to heat the substrate 4 in contact with the surface of the support roller 30.

The support roller 30 is, in an embodiment, arranged to support the substrate 4 at least from the coating zone to the distal portion 54 of the flexible film 5 and is designed to heat the coated layer 6 at least from the coating zone to the distal portion 54 of the flexible film 5.

In an embodiment, the coating module 1 comprises a system to heat the coated layer 6 by radiation.

Such a system may comprise an infrared source, or any other source of thermal radiation which is arranged to heat the flexible film 5. In this embodiment, the flexible film 5 is made of a material converting the radiation emitted by the source of thermal radiation into heat. For this purpose, the flexible film 5 may be made from a metal sheet such as a gold sheet or a titanium sheet.

In another embodiment, the source of thermal radiation may be replaced by a source of radiation, such as a UV source able to start polymerization or reticulation in depth of the coated layer.

In such embodiments, the flexible film 5 is made in a material transparent to the radiation emitted by the source of radiation or by the source of thermal radiation.

### Example 1: Slot-Die Coating Device

FIG. 1 shows an embodiment of a coating module according to the invention. The coating device 2 comprises a slot-die coating device 21. The slot-die coating device 21 is designed to melt and distribute the coating composition 6 onto the substrate 4. The slot-die coating device 21 may also comprise a fluid reservoir to store the main supply of coating composition and a pump to drive the coating composition through an inlet 23 of the slot-die head 21. The slot-die further comprises a slot 22 formed to apply a coating composition to a substrate 4 designed to meter the amount of the coating composition, for example to a 2 μm foil substrate with a basis weight of 10 g/m² and a wet coating thickness around 1.5 μm.

While the coating composition is extruded out of the slot die, a meniscus is created between the slot die tip and the substrate where flow instabilities could arise. The presence of the flexible film 5 prevents ribbing induced by such flow instabilities and levels the thin coated layer.

In addition, slot-die coating is often chosen to produce stripes along the coating direction. The use of several sections of the flexible film 5 in an array across the substrate's width allows leveling of the coating composition as well as the sharpness at the edge of each coated stripe. Risk of overlapping stripes is therefore significantly reduced, and coating neatness is enhanced.

The conveyor system 3 is designed to drive the relative speed of the substrate 4 in regard to the slot-die coating device 21.

In the embodiment illustrated in FIG. 1, the conveyor system 3 comprises at least two rollers 30 displayed to support the substrate 4 on both sides of the slot-die coating device 21.

### Example 2: Ink Roller Coating Device

FIG. 2 illustrates another embodiment of a coating module 1 according to the invention. In this embodiment, the coating device 2 comprises an ink roller 24. The ink roller 24 is mounted to rotate on itself to transport ink on its circumferential surface. Coating occurs while the circumferential surface of the ink roller is in contact with the substrate to transfer the coating composition with a given thickness.

In an embodiment, the circumferential surface of the ink roller 24 is engraved and comprises depressions regularly arranged, forming a set of grooves, cavities or a pattern. The depth of these depressions is comprised between 5 μm and 50 μm. These depressions beneficially allows to transport coating composition until the ink roller 24 is in contact with the substrate 4.

The ink roller may be an anilox roller or a roller for flexography.

### Example 3: Thermal Transfer Printing Apparatus

In another aspect, the invention relates to a thermal transfer printing apparatus 200 with an endless ribbon. Such thermal transfer printing apparatus 200 is now described in reference to FIG. 8.

The thermal transfer printing apparatus comprises a coating module 1, which could be any kind of coating device. In this example the coating device is an ink roller designed to squeeze a molten ink against the coating substrate. The substrate is an endless ribbon such as a polyimide-based ribbon and is driven by the conveyor system by its inner side along a path defined by an arrangement of rollers.

The thermal transfer printing apparatus 200 comprises a printhead 101 to thermally transfer a part of the coated layer 6 from the ribbon to the printing support 202. The endless ribbon 4 is then transported from the printhead 101 to the coating device 1 to be recoated.

The thermal transfer printing apparatus 200 further comprises plurality of rollers 201, 204 holding and transporting said endless ribbon 4.

In an embodiment, the thermal transfer printing apparatus further comprises a cooling element. The cooling element is designed to actively cool down the coated layer 6 on the ribbon between the printhead 101 and the coating device 1. In an embodiment, the flexible film 5 is arranged to be in contact with the substrate 4 between the coating device 1 and the cooling element 201.

As explained before, the cooling element may comprise a cooling roller in contact with the inner surface of the substrate 4.

The printing apparatus 200 comprises a printhead 101. In an embodiment, the printhead 101 is a thermal transfer printhead.

In a first mode, the printhead 101 is in contact with the inner face of the ribbon 4 to enable the thermal transfer of the ink located in the outer face of the ribbon 4. During this printing process, the outer face of the ribbon 4 is in contact (for example in pressurized contact) with a substrate 202, such as a paper sheet (called “printing support” in the present specification) to transfer the part of ink intended for printing the printing support 202.

In a second mode, the printhead 101 is not in contact with the endless ribbon 4. This mode may be engaged when the printing apparatus is switched off or during two successive printing sequences. The alternance of the first and second mode may be configured depending on the printing mode.

At least one print roller 203 or a print plate can be used to transport a printing support 202 in contact with the ribbon 4 while thermal transfer is occurring. The thermal transfer printhead 101 is designed to transfer hot melt ink from the ribbon 4 to the printing support 202. The arrangement between the printhead 101, the ribbon 4 and the printing support 202 may be ensured by mechanical components which are precisely set according to a desired printing precision. Some guides and position control components may be implemented in order to ensure a predefined arrangement between at least the printhead 101 and the ribbon 4.

The print rollers 203 ensure a sufficient pressure on the printing support 202 in order to maintain the printing support 202 in contact with the ribbon 4 when printing process is engaged. In this configuration, such a ribbon 4 is maintained in a moving sandwich layer between the printing support 202 and the printhead 101 during the printing process. The movement of the printing support 202 is in the same direction as the displacement direction of the ribbon 4 in the vicinity of the printhead 101. This movement in the vicinity of the printhead is, in an embodiment, a rectilinear movement.

The ribbon 4 of the printing apparatus 200 allows the transport of the ink from the coating module 1 to the printhead 101 on its outer face.

The printing process is implemented such to form a continuous looping process. During printing, the printhead 101 is in contact with the inner face of the ribbon 4 to enable the thermal transfer of the ink located in the outer face of the ribbon 4 to the printing support 202. After printing, the endless ribbon 4 is transported from the printhead 101 to the coating device 1 to be recoated. The residual ink is then retrieved, and the coated layer is replenished by the coating device. This configuration allows recovery and rejuvenation of the partially voided ink layer that has not been printed. Ink may be beneficially reused on a next turn of the ribbon 4.

### Example 4: Coating Over Coating Drum

In an embodiment illustrated in FIG. 9, the substrate is a coating drum 37. The coating drum 37 comprises a cylinder such as a cylinder of revolution. The conveyor system comprises a system adapted to rotate the coating drum around the longitudinal axis A of the cylinder of the coating drum 37.

The conveyor system may comprise a driving shaft 38 to drive in rotation the coating drum 37. The coating drum 37 is driven in rotation by a motor connected to the driving shaft 38.

The coating device 2 is arranged to coat the outer surface of the coating drum 37 while the coating drum is rotating. The flexible film 5 is arranged to be in contact with the coated layer as explained in the present specification.

The coating drum may be used to support one or several coating layers designed to produce a band or an endless ribbon using one or several coating layers. Such substrate beneficially allows creating a seamless band or endless ribbon with the coating composition with an improved surface aspect. The band could be used as a substrate for coating in the thermal printer described above.

### Example 5: Knife Coating

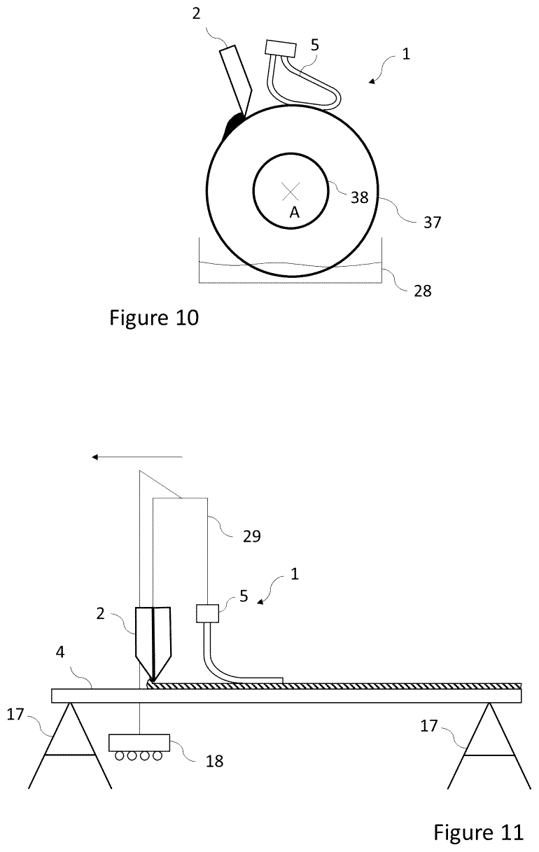

FIG. 10 illustrates another embodiment of a coating drum 37 according to an embodiment of the invention.

In this illustrated embodiment, the coating drum is partially immersed within a tank 28 filled with a coating composition. A stationary knife-coating device 2 is provided to control the thickness of the coated layer within the coating drum.

The rotation of the coating drum within the coating composition continuously supplies the meniscus standing between the substrate and the knife. The substrate movement ensures the layer deposition as it passes the knife. The thickness of the coated layer is related to the gap size between the knife and the substrate and to some extent also to the substrate speed. Knife coating is suitable for the deposition of homogeneous layers in large areas and can be carried out at high speed (>10 m/s).

A flexible film is also provided and is arranged in such a way that a distal portion of the flexible film is in contact with the coated surface of the coating drum 37.

### Example 6: Mobile Coating Module

In an embodiment illustrated in FIG. 11, the coating device 2 and the flexible film 5 are mechanically connected by an arm 29. The arm 28 is connected to a mobile base 18. The mobile base is movable on the ground. In one embodiment, the mobile base 18 comprises one or several wheels to move in translation on the ground.

In this embodiment, the substrate 4 is fixed. In an example, the substrate is arranged on a fix support 17.

During coating, the base 18 is moved along a trajectory in such a way that both the coating device and the flexible film move along or across the substrate 4. In this embodiment, the “direction of transport of the substrate” should be understood as the direction of the substrate in regard to the coating device 2.

### Example 7: Cleaning System

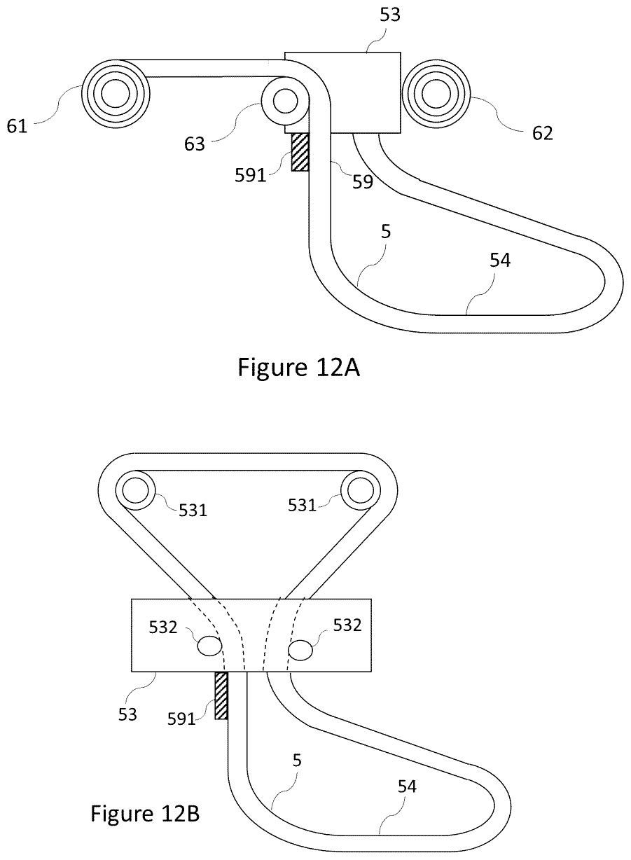

In an embodiment illustrated in FIGS. 12A and 12B, the coating module comprises a cleaning system 591 adapted to clean a portion 59 of the flexible film 5. In an embodiment, the cleaning system 591 comprises a foam or a sponge arranged to be in contact with the surface of the flexible film 5. A benefit is to clean the surface which was in contact with the coated layer of the substrate. The flexible film 5 can therefore be reused, and the lifetime of the coating module is beneficially improved.

In another embodiment, the cleaning system 591 comprises a tank filled of a cleaning solution arranged in such a way that the flexible film passes through the cleaning solution. In an embodiment, the composition of the cleaning solution is designed to remove ink from the flexible film.

As illustrated in FIG. 12A, the cleaning system 591 is arranged between the distal portion 54 and the first unit 61 to wind-out the flexible film. When the flexible film 5 is wound within the first unit 61, the flexible film 5 is cleaned by the cleaning system 591. When the flexible film 5 is unwound from the first unit 61 and wound into the second unit 62, the new distal portion of the flexible film 5 is cleaned after two passages through the cleaning system. In an embodiment, the coating module comprises a roller 63 to guide the endless ribbon between the cleaning system 591 and the first unit 61.

In another embodiment illustrated in FIG. 12B, the flexible film 5 is an endless flexible film forming a loop. The path of the flexible film forming a loop is predefined by the position of several support elements 531, 532 The cleaning system is arranged to clean a portion of the flexible film.

In an embodiment, the cleaning system 591 is in contact with a portion of the endless flexible film between the distal part 54 and a support element 532 supporting the flexible film 5. A benefit is to clean the flexible film before being in contact with a support element. It beneficially reduces the risk of getting such support element dirty with remaining ink or coating composition.

In an embodiment, the cleaning system 591 is embedded or fixed to the holding element 53.

The coating module, in an embodiment, comprises an additional conveyor system adapted to drive the flexible film along a predefined path passing through the cleaning system 591. This conveyor system may comprise rollers 531 and/or driving rollers 532 to drive the flexible film.

In an embodiment, the coating module comprises a controller adapted to control the first and/or the second unit or the additional conveyor system to control the passage of the flexible film 5 through the cleaning system 591.

Process Implemented

According to another aspect, the invention refers to a process to coat a substrate. In an embodiment, the process is implemented with a coating module and/or a flexible film according to the present description.

The process comprises a first step to coat the outer surface of the substrate with a coating composition. The coating composition is coated by the coating device while the substrate is driven at a relative speed in regard to the coating device and/or the holding element 53.

As explained before, the coating may be performed by any coating device such as a slot-die coating device, a knife-coating device or an ink roller.

In a second step, the wet-coated layer in the substrate is driven along a predefined path in contact with the distal portion 54 of the flexible film 5.

In an embodiment, the coated layer is sliding along the distal portion of the flexible film on a distance superior to 5 mm, for example on a distance superior to 1 cm.

The process further may comprise a downstream step to dry, cool, or cure the coating layer after passing under the flexible film. The dryness or the solidification of the coating composition may occur after the step of operating the sliding along the distal portion of the flexible film. This solidification may be achieved by evaporation of the solvent present in the coating composition or by cooling the coating composition below its glass transition temperature.

In an alternative embodiment, the coating device 2 and the distal portion 54 of the flexible film are driven along a predefined path in contact with the outer surface of the substrate. In any cases, the substrate is moving relative to the coating device and/or the holding element of the flexible film.

The cooling of the coating composition may be achieved by contact between the substrate and a cooling roller, or any other cooling device as previously described, including a fan.

The process could further comprise a system adapted to switch the substrate face: the inner face becoming the outer face and the outer face becoming the inner face, in respect to the coating device, as to coat a substrate on both sides. In this implementation, at least one flexible film could be used to smooth the relative upper coated layer.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

It will be appreciated that the various embodiments and aspects of the invention described previously are combinable according to any technically permissible combinations.

1. A coating module to coat a substrate with a coating composition comprising:
a coating device adapted to apply a layer of coating composition on a first surface of the substrate, and
a flexible film comprising at least one proximal end that is mechanically connected to a holding element and a free distal portion configured to be in contact with the layer of coating composition on the first surface of the substrate.

2. The coating module according to claim 1, further comprising a conveyor system adapted to support and transport the substrate by a second surface of the substrate opposite the first surface.

3. The coating module according to claim 2, wherein the conveyor system comprises a support roller.

4. The coating module according to claim 2, wherein the conveyor system comprises a temperature regulator configured to heat to or cool a portion of the substrate.

5. The coating module according to claim 1, wherein the flexible film further comprises openings, grooves or fibers.

6. The coating module according to claim 1, further comprising a system adapted to apply pressure on the distal portion of the flexible film.

7. The coating module according to claim 1, further comprising a holding element and a frame, the flexible film being fixed to said holding element, wherein the holding element is mechanically connected to the frame by one or two lateral extremities.

8. The coating module according to claim 7, wherein the holding element is removable from the frame.

9. The coating module according to claim 1, further comprising a source of electromagnetic radiation arranged to irradiate the coating composition underneath the distal portion of the flexible film and wherein the flexible film is transparent to such electromagnetic radiations emitted by said source.

10. A coating system comprising a coating module according to claim 1, and a substrate, the coating device being arranged to coat a surface of the substrate and the flexible film being arranged so that its distal portion is in contact with the coated substrate.

11. A thermal transfer printing apparatus, comprising:
a coating system according to claim 10, wherein the substrate is an endless ribbon,
a conveyor system comprising a set of rollers adapted to transport the substrate along a path,
a printing roller adapted to transport a printing support in contact with the first surface of at least a portion of the substrate (4);
a printhead arranged to thermally transfer a part of the coating composition from the first surface of the substrate to the printing support in contact with the substrate.

12. A system for producing an endless ribbon comprising a coating system according to claim 10, wherein the substrate comprises a coating drum comprising a cylinder and for a system adapted to rotate the coating drum around a longitudinal axis of said cylinder.

13. A method to coat a substrate, comprising:
providing a coating module according to claim 1;
coating a first surface of the substrate with coating composition to form a layer of coating composition with the coating device;
transporting the substrate along a predetermined path so that a portion of the flexible film lays over the layer of coating composition before its solidification, dryness or complete cure.

14. The method to coat a substrate according to claim 13, wherein said coating comprises coating the first surface of the substrate with at least two layers of coating composition in parallel, separated one from each other, and wherein the coating module comprises at least two flexible films, each flexible film is arranged to lay over one layer of coating composition.

15. A method to coat a substrate, comprising:
providing a coating module according to claim 1;
coating a first surface of the substrate with coating composition with a coating device to form a layer of coating composition with the coating device, and
transporting the coating device and the flexible film along a predetermined path so that a portion of the flexible film lays over the layer of coating composition before its solidification, dryness or complete cure.
